(19) United States
(12) Patent Application Publication
(10) Pub. No.: US 2009/0312483 A1
(43) Pub. Date: Dec. 17, 2009

(54) PRESSURE SENSITIVE ADHESIVE

(76) Inventor: Ralph P. Kitson, Jefferson, OH (US)

Correspondence Address: Avery Dennison Corporation;Amanda Wittine, 8080 Norton Parkway, 22-D, Mentor, OH, 44060, US

(21) Appl. No.: 11/915,880

(22) PCT Filed: Jun. 2, 2006
(86) PCT No.: PCT/US06/21720

§ 371 Date: Nov. 29, 2007

Related U.S. Application Data
(60) Provisional application No. 60/693,225, filed on Jun. 23, 2005.

(51) Int. Cl. C09J 109/06; C09J 153/02

(52) U.S. Cl. 524/505

(57) ABSTRACT

A hot melt pressure sensitive adhesive composition contains an elastomeric component that includes a solid rubber and a liquid rubber, and a tackifier component. The solid rubber component may contain a blend of SIS/SI and SBS/SB block copolymers. The hot melt pressure sensitive adhesive is particularly useful in label constructions.

This application claims the benefit of provisional application Ser. No. 60/693,225 filed on Jun. 23, 2005, which is hereby incorporated herein by reference in its entirety.

### FIELD OF THE INVENTION

The present invention is directed to elastomer or rubber based pressure sensitive adhesive compositions used in label and tape manufacture.

### BACKGROUND

Adhesive labels and tapes are well known. In a typical label construction, one or more layers of adhesive are coated on or otherwise applied to a release liner, and then laminated to a facestock, such as paper, polymeric film, or other ink-receptive, flexible material. In a typical tape construction, a polymeric film or woven paper is coated with an adhesive on one surface, which is then wound up upon itself. A release liner is not generally required. Labels are usually die-cut and matrix-stripped before use. In contrast, tapes usually do not require die-cutting and matrix-stripping, and generally need not be ink-receptive.

The adhesives used in both tapes and labels include pressure-sensitive adhesives (PSAs). Both rubber-based and acrylic-based PSAs are known; most contain one or more tackifiers that improve overall adhesion to various substrates. PSAs can be applied to a release liner or facestock from an organic solvent, from an aqueous dispersion, or as a hot melt. Hot melt PSAs are highly desirable, as the absence of solvent or water lowers the energy required to form the adhesive layer and reduces the environmental problems associated with solvent-borne adhesives.

A typical rubber-based hot melt PSA composition contains one or more natural or synthetic elastomers, tackified with a petroleum resin and/or other ingredients, such as plasticizers, that improve the tack of the adhesive.

### SUMMARY OF THE INVENTION

According to the present invention, hot melt pressure sensitive adhesive compositions and label constructions are provided.

In one embodiment, a hot melt pressure-sensitive adhesive composition comprising 100 parts by weight of a rubber component that is solid; 5 to 24 parts by weight of a liquid rubber component; and 100 to 170 parts by weight of a tackifier is provided.

In one embodiment, an adhesive article construction comprising a facestock; and a hot melt pressure sensitive adhesive composition comprising (i) 100 parts by weight of a rubber component that is solid, the solid rubber component comprising (a) at least one styrene-butadiene-styrene (SBS) block copolymer or a styrene-butadiene (SB) block copolymer and (b) at least one styrene-isoprene-styrene (SIS) block copolymer, or a mixture of SIS and styrene-isoprene (SI) block copolymer; (ii) 5 to 24 parts by weight of a liquid isoprene-butadiene copolymer; and (iii) 100 to 170 parts by weight of a tackifier is provided.

### DETAILED DESCRIPTION

The hot melt pressure sensitive adhesive is prepared by combining a solid rubber and a liquid rubber. In one embodiment, the amount of liquid rubber used is in the range of about 5 parts to about 24 parts, based on 100 parts of solid rubber. In one embodiment, the amount of liquid rubber used is in the range of about 10 parts to about 15 parts, based on 100 parts of solid rubber.

### Solid Rubber:

The solid rubbers used in the present invention are natural or synthetic elastomeric polymers, including, for example, polybutadiene, polyisoprene (both natural rubber and synthetic polymers); and AB, ABA, and “multiarmed” (AB)_{X} block copolymers, where for example, A is a polymerized segment or “block” of at least one monoalkenylarene, such as styrene, alpha-methyl styrene, vinyl toluene and the like, B is an elastomeric, conjugated polybutadiene or polyisoprene block, and x has a value of three or more. Other radial block copolymers (described below) may also be employed.

In one embodiment of the invention, the solid rubber elastomeric component comprises an SIS block copolymer, or a mixture of SIS and SI block copolymers, where “S” denotes a polymerized segment or “block” of styrene monomers, and “I” denotes a polymerized segment or “block” of isoprene monomers. More generally, the elastomeric component comprises a first styrenic elastomer, for example SIS block copolymers, SI block copolymers, multiarmed (SI)ₓ block copolymers where x is 3 or more, radial block copolymers comprising an SI backbone and I and/or SI arms, and mixtures of such copolymers. The elastomeric component may, and preferably does, further comprise a second styrenic elastomer, for example SBS block copolymers, SB block copolymers, multiarmed (SB)_{X} block copolymers where x is 3 or more, radial block copolymers comprising an SEBS backbone and I and/or SI arms (where “E” and “B” are, respectively, polymerized segments of ethylene and butylene), and mixtures thereof. Other nonlimiting examples of elastomers are polybutadiene and polyisoprene.

Monoalkenylarene block copolymers can be prepared using anionic polymerization techniques that are well known in the art. Commercially available isoprene-based elastomers useful in the practice of the present invention include linear SIS and/or SI block copolymers, for example, Quintac 3433 and Quintac 3421, available from Nippon Zeon Company, Ltd.; Vector DPX 559, Vector 4111 and Vector 4113, available from Dexco, a partnership of Exxon Chemical Co. (Houston, Tex.) and Dow Chemical Co. (Midland Mich.); and Kraton® rubbers, such as Kraton® 604x, Kraton® D-1117, Kraton® D-1107 and Kraton® D-1113, available from Kraton Polymers. Kraton® D-1107 is a predominantly SIS elastomer containing about 15% by weight SI block copolymers and a specific gravity 0.92. Kraton® 604x is an SIS elastomer containing about 55% SI block copolymers. Kraton® D-1320X is an example of a commercially available (SI)ₓI_{y} multiarmed block copolymer in which some of the arms are polyisoprene blocks. Commercially available butadiene-based elastomers include SBS and/or SB rubbers, for example Kraton® D-1101, D-1102 and D-1118X, from Kraton Polymers; and Solprene 1205, a linear random-block SB copolymer having a reported bound styrene content of 25%, a block styrene content of 17.5%, and a specific gravity of 0.93 available from Housemex, Inc. (Houston, Tex.). Other examples of commercially available block copolymers useful in the practice of the present invention include Kraton® TKG-101 (sometimes called “Tacky G”), a radial block copolymer haying an SEBS backbone and I and/or SI arms.

In one embodiment, the solid rubber component comprises a blend of a styrene/isoprene copolymer and a styrene/butadiene copolymer. In one embodiment, the solid rubber component comprises a blend of (a) a styrene-butadiene-styrene (SBS) copolymer, a styrene-butadiene (SB) copolymer, or a mixture thereof; and (b) a styrene-isoprene-styrene (SIS) copolymer, styrene-isoprene (Si) copolymer, or a mixture thereof.

The weight ratio of the SBS/SB copolymers of (a) to the SIS/SI copolymers of (b) can be within the ranges of about 0.3:1 to about 1:1.

### Liquid Rubber:

Liquid rubbers useful in the adhesive include synthetic liquid isoprene rubber, depolymerized natural rubber, carboxyl terminated synthetic liquid isoprene-styrene rubber, hydroxyl terminated synthetic liquid isoprene rubber, hydrogenated liquid isoprene rubber, liquid isoprene-styrene copolymer, liquid isoprene-butadiene and liquid butadiene-styrene copolymer. Liquid rubbers also useful in the adhesive include liquid polybutadiene, liquid hydrogenated butadiene, liquid styrene-ethylene-butylene and liquid styrene-ethylene-propylene. The liquid rubbers generally have a molecular weight of about 20,000 to about 60,000. In one embodiment, the liquid rubber has a glass transition temperature (Tg) of less than about −50° C., and in one embodiment, less than about −75° C.

A commercially available liquid rubber useful in the adhesive composition is LIR-390, a butadiene/isoprene rubber from Kuraray Company that has a reported molecular weight of 48,000, a Tg of −95° C. and a melt viscosity of 300 Pa-s at 38° C.

### Tackifiers:

Nonlimiting examples of normally solid and normally liquid tackifiers include the Wingtack family of resins sold by the Chemical Division of Goodyear Tire and Rubber Company (Akron, Ohio). Wingtack® resins have a numerical designation that corresponds to the softening point of the resin, i.e., Wingtack® 95 is normally a solid at room temperature, with a softening point of about 95° C., Wingtack® 10 is normally a liquid at room temperature, with a softening point of about 10° C., Wingtack® ET is an aromatically modified C5 hydrocarbon resin with a softening point of about 94° C. Other normally solid tackifiers include Escorez 1304, Escorez 1310-LC, and Escorez 2596, manufactured by Exxon Chemical Co. (Houston, Tex.), and Piccotac 95, manufactured by Hercules Inc. (Wilmington, Del.). Solid and liquid tackifiers can be prepared by polymerization of a stream of aliphatic petroleum derivatives in the form of dienes and monoolefins, in accordance with the teachings of U.S. Pat. Nos. 3,577,398 and 3,692,756. Another useful commercially available tackifier is Eastotac H-100W, a hydrogenated petroleum based tackifier from Eastman Chemical Company.

In some embodiments, the adhesive composition may contain additional tackifiers, such as rosins, rosin esters, and polyterpenes, and/or a plasticizer, such as Shellflex 371 (manufactured by Shell Chemical Co.) and Kaydol Mineral Oil (manufactured by Witco Chemical Corp., Houston, Tex.). The additional tackifiers and/or plasticizers can be added to the formulation to adjust the Tg, viscosity, or other properties of the adhesive.

### Plasticizers:

Useful plasticizers include plasticizing oils such as low aromatic content hydrocarbon oils that are paraffinic or naphthenic in character. Commercially available plasticizers include Shellflex 371 from Shell Chemical Co., Kaydol Mineral Oil from Witco Chemical Corporation, Tufflo oils from Arco and Nyflex 222B naphthenic oil from Nynas Naphthenics.

Other components may be added to modify the tack, the odor and the color of the adhesives. Antioxidants and other stabilizing ingredients may be added to protect the adhesive from degradation caused by heat, light and/or processing or during storage. Waxes, surfactants, talc or powdered silicates or filler agents may be incorporated during processing.

In one embodiment, the hot melt adhesive is clear.

### Facestock:

A wide variety of facestocks can be used with the adhesive to manufacture adhesive articles such as labels and tapes. The facestock material may include paper, cardboard, and polymeric film materials such as polyolefins (e.g., polyethylene, polypropylene, ethylene-propylene copolymers, etc.). Other polymeric film materials include urethane based polymers such as polyether urethane and polyester urethane, amide based polymers including polyether polyamide copolymers, acrylic based polymers including a polyacrylate, and ethylene/vinyl acetate copolymer, polyester based polymers including a polyether polyester, a vinyl chloride, a vinylidene chloride, a polystyrene, a polyacrylonitrile, a polycarbonate, a polyimide, or the like. The facestock may be a monolayer material or a multilayer construction. The facestock may comprise a flexible facestock. The facestock may comprise a transparent polymeric film.

### Examples

The following examples are given only by way of illustration and are not intended to limit the scope of the invention in any way.

With respect to the following examples, the ingredients listed are identified as follows:

Vector 4113 is an SIS/SI block copolymer.
Solprene 1205 is a linear random-block SB copolymer having a reported bound styrene content of 25%, a block styrene content of 17.5%, and a specific gravity of 0.93.
LIR-390 is a butadiene/isoprene rubber from Kuraray Company that has a reported molecular weight of 48,000, a Tg of −95° C. and a melt viscosity of 300 Pa-s at 38° C.
Wingtack ET is an aromatically modified C5 hydrocarbon tackifier with a softening point of about 94° C.
Eastotac H100W is a petroleum based hydrogenated tackifier.
Nyflex 222B is a naphthenic oil.
Mayzo AO is an anti-oxidant

### Example 1

A hot melt composition is compounded using a one liter sigma blade mixer, and coated using a hot-melt coater onto a release liner and then laminated to a 2 mil clear biaxially oriented polypropylene (BOPP) film. The adhesive comprises a blend of SB and SIS solid rubbers.

| Ingredients | Wt. % |
|---|---|
| Vector 4113 | 23.45 |
| Solprene 1205 | 9.59 |
| LIR-390 | 4.26 |
| Wingtack ET | 25.59 |
| Eastotac H100W | 25.59 |
| Nyflex 222B | 10.66 |
| Mayzo AO | 0.85 |

In use, the pressure sensitive adhesives of the invention may be employed as part of a label laminate or facestock and PSA provided as a self wound tape or label. In one embodiment, the acrylic emulsion PSA is applied to a transparent polymeric facestock to form a clear label. The polymeric facestock may be a polyolefin, polyester, polyvinyl chloride, polycarbonate film or a multilayer construction comprising layers of the same or different polymers. The multilayer films may be coextruded films. Examples of commercially available multilayer films include FasClear® film and Primax®film from Avery Dennison Corp. The label may comprise a release liner adhered to the acrylic emulsion PSA. The tapes or labels may be applied to clear substrates such as glass or plastic bottles and containers and the like.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A hot melt pressure-sensitive adhesive composition comprising
100 parts by weight of a rubber component that is solid, wherein the solid rubber component comprises (a) a styrene-butadiene-styrene (SBS) copolymer, a styrene-butadiene (SB) copolymer, or a mixture thereof and (b) a styrene-isoprene-styrene (SIS) copolymer, styrene-isoprene (SI) copolymer, or a mixture thereof, and the weight ratio of (a):(b) ranges from about 0.3:1 to about 1:1;
5 to 24 parts by weight of a liquid rubber component; and
100 to 170 parts by weight of a tackifier.

2. The adhesive composition of claim 1 wherein the liquid component comprises an isoprene-butadiene copolymer.

3. The adhesive composition of claim 1 wherein the tackifier comprises a petroleum based tackifier.

4. The adhesive composition of claim 1 wherein the tackifier comprises a petroleum based hydrogenated tackifier.

5. The adhesive composition of claim 1 further comprising a plasticizinq oil.

6. The adhesive composition of claim 1 wherein the adhesive is clear.

7. (canceled)

8. (canceled)

9. An adhesive article construction comprising
a facestock; and
a hot melt pressure sensitive adhesive composition comprising (i) 100 parts by weight of a rubber component that is solid, the solid rubber component comprising (a) at least one styrene-butadiene-styrene (SBS) block copolymer or a styrene-butadiene (SB) block copolymer and (b) at least one styrene-isoprene-styrene (SIS) block copolymer, or a mixture of SIS and styrene-isoprene (SI) block copolymer, and the weight ratio of (a):(b) ranges from about 0.3:1 to about 1:1; (ii) 5 to 24 parts by weight of a liquid isoprene-butadiene copolymer; and (iii) 100 to 170 parts by weight of a tackifier.

10. The adhesive article construction of claim 9 wherein the facestock is transparent.

11. The adhesive composition of claim 1 wherein the solid rubber component comprises (a) a styrene-butadiene (SB) block copolymer and (b) a mixture of styrene-isoprene-styrene (SIS) and styrene-isoprene (SI).

12. The adhesive composition of claim 11 wherein the styrene-butadiene (SB) block copolymer has a block styrene content of 17.5%.

13. The adhesive article of claim 9 wherein the solid rubber component comprises (a) a styrene-butadiene (SB) block copolymer and (b) a mixture of styrene-isoprene-styrene (SIS) and styrene-isoprene (SI).

14. The adhesive article of claim 13 wherein the styrene-butadiene (SB) block copolymer has a block styrene content of 17.5%.
